(19) United States
(12) Patent Application Publication
(10) Pub. No.: US 2017/0355006 A1
(43) Pub. Date: Dec. 14, 2017

(54) Flange Assembly for Heater Treaters and Other Vessels

(71) Applicant: Global Vessel & Tank, LLC, Lafayette, LA (US)

(72) Inventor: Krieg M. Allen, Lafayette, LA (US)

(21) Appl. No.: 15/621,650

(22) Filed: Jun. 13, 2017

Related U.S. Application Data
(60) Provisional application No. 62/349,919, filed on Jun. 14, 2016.

(51) Int. Cl. B21D 19/04; B01D 21/34; F24F 13/02; B01D 21/00

(52) U.S. Cl. CPC B21D 19/046; F24F 13/0209; B01D 21/34; B01D 2221/04; B01D 21/0003

(57) ABSTRACT

An oval-shaped flange assembly for use on heater treaters and other heated and/or pressurized separation vessels. A first substantially oval-shaped, raised face blind flange member operationally attached to a fire tube mates with an opposing oval-shaped, raised face slip-on flange member attached to a heater treater or other pressurized vessel. An alignment guide pin facilitates fast and efficient connection and disconnection of the flange members.

### CROSS REFERENCES TO RELATED APPLICATION

Priority of U.S. Provisional Patent Application Ser. No. 62/349,919, filed Jun. 14, 2016, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

### 1. Field of the Invention

The present invention pertains to a connection assembly for use in connection with vessels. More particularly, the present invention pertains to a flange assembly for use on oil and gas processing equipment. More particularly still, the present invention pertains to a flange assembly for use with fire tubes of heat-treating separator vessels.

### 2. Brief Description of the Prior Art

Generally, processing equipment in the oil and gas industry has remained substantially unchanged for many years with very little variation in design or innovation. One such piece of equipment that has remained essentially unchanged over time is the emulsion/oil treating vessel or heated separator, which is also commonly referred to as a “heater treater”.

Conventional heater treaters generally comprise a vessel defining an inner chamber. A fire tube—typically in the shape of a “U” or other similar configuration—at least partially extends into said inner chamber. A fire or other heat source provides heat energy to said fire tube, typically within the inner portion of said tube. Heater treaters can be found on both onshore (land) and marine locations, and are commonly used in very low pressure or artificial lift applications.

Fluids produced from subterranean wellbore (typically oil, other liquid hydrocarbons, water, natural gas and/or combinations thereof) are introduced into said inner chamber. Heat from the fire tube is transferred from said fire tube to such fluids contained within the inner chamber of the heater treater vessel. Application of heat to said fluids helps to improve separation of such components.

Originally, conventional heater treaters comprised relatively small vessels designed for relatively low pressure service, typically with a Maximum Allowable Working Pressure (“MAWP”) of 25 psi or less. Over time, the size (fluid capacity) and MAWP of such vessels have increased significantly; in some instances, conventional heater treaters can exceed 8 feet in diameter with a MAWP in excess of 250 psi. Nonetheless, despite such dramatic increases in size and operating parameters, the basic design of heater treaters has not changed. As a result, such conventional heater treaters are frequently being used in applications for which they were never designed.

Fire tube flange assemblies of conventional heater treater vessels often sustain significant damage and have high potential for failure. Such conventional fire tube assemblies, which are used to mount a fire tube within the internal chamber of a heater treater vessel, generally comprise mating bolted flanges having a neoprene rubber gasket disposed said flanges. As operating conditions become more extreme MAWPs increase, such flange assemblies (including, without limitation, such rubber gaskets) are frequently at risk of failing.

When said rubber gaskets degrade—particularly over time—said conventional flange assemblies can lose fluid pressure seal integrity, resulting in fluid leakage from said flange assemblies. Such fluid leakage can negatively impact the environment surrounding a heater treater, resulting in significant remediation expense and production downtime. Moreover, because leaking fluids can be flammable (such as oil, natural gas or other hydrocarbons) and/or toxic, such fluids can cause bodily injury or death to personnel.

Further, fire tube flange assemblies generally are not universal or interchangeable. As a result, it is frequently difficult and/or expensive to change out fire tubes between heater treater vessels because attachment flanges often do not match from one heater treater to another. Heater treater manufacturers generally each make their own flange pattern or design; fire tubes from one manufacturer generally cannot replace the fire tubes of another manufacturer.

Thus, there is a need for a fire tube flange assembly for use on heater treater vessels. The fire tube flange assembly should provide greater pressure sealing integrity, while permitting efficient removal and installation of heater treater fire tubes.

### SUMMARY OF THE INVENTION

The present invention comprises a substantially oval-shaped raised face blind flange member. Said raised face blind flange member has a plurality of holes for receiving a fire tube of a conventional heater treater or other heated separator vessel. A plurality of bores is disposed around said oval-shaped, raised face blind flange member in spaced relationship.

A mating substantially oval-shaped, raised face slip-on flange member, also sometimes referred to as a vessel flange member, is provided on said heater treater or other heated separator vessel. A plurality of bores is disposed around said oval-shaped, raised face blind flange member in spaced relationship. In a preferred embodiment, dimensions of said raised face slip-on flange member are substantially consistent with the dimensions of said raised face blind flange member, allowing said opposing flange members to be secured together against each other in mating face-to-face relationship.

At least one alignment pin extends outwardly from said raised face slip-on flange member in a substantially perpendicular orientation or direction. At least one alignment aperture is provided on said raised face blind flange member; said at least one alignment aperture is beneficially aligned with said at least one alignment pin and adapted to receive said at least one alignment pin.

In a preferred embodiment, said bores disposed around said raised face slip-on flange member are aligned with bores disposed around said raised face blind flange member. Fasteners can be received within each set of aligned bores in order to apply compressive forces to said opposing flange members and secure said flange members together. By way of illustration, but not limitation, said fasteners can each comprise threaded bolts and threaded nuts.

In a preferred embodiment, each of said oval-shaped, raised face blind flange member and said oval-shaped, raised face slip-on flange member complies with ANSI B16.5 Class 75, 150, 300, 600, and/or 900 series specifications, including bolt pattern and type requirements. Further, a non-asbestos sealing gasket is disposed between said opposing flange members.

The present invention eliminates current risks and limitations associated with conventional flange designs. Among other benefits, the flange assembly of the present invention provides improved safety, and allows for quick and efficient replacement and/or repair. Further, because said flange assembly provides greater fluid pressure sealing capacity, said flange assembly of the present invention permits safe operation of heater treaters and/or other heated separator vessels at higher MAWPs.

### BRIEF DESCRIPTION OF DRAWINGS/FIGURES

The present invention comprises a substantially oval-shaped, raised face blind flange member. Said raised face blind flange member has a plurality of holes for receiving a fire tube of a conventional heater treater or other heated separator vessel. A plurality of bores is disposed around said oval-shaped, raised face blind flange member in spaced relationship.

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective view of an outer surface of a raised face blind flange member of the present invention.

FIG. 2 depicts a side perspective view of an inner surface of a raised face blind flange member of the present invention.

FIG. 3 depicts a sectional view of a raised face blind flange member of the present invention along line 3-3 of FIG. 2.

FIG. 3A depicts a detailed view of the area highlighted area 3A depicted in FIG. 2.

FIG. 4 depicts a side perspective view of an inner side of a raised face blind flange member of the present invention equipped with a conventional fire tube.

FIG. 5 depicts a side view of a raised face blind flange member of the present invention equipped with a conventional fire tube.

FIG. 6 depicts a perspective view of an inner side of a raised face slip-on flange member of the present invention.

FIG. 7 depicts a perspective view of an outer side of a raised face slip-on flange member of the present invention.

FIG. 7A depicts a detailed view of the area highlighted area 7A depicted in FIG. 7.

FIG. 8 depicts a sectional view of a raised face slip-on flange member of the present invention along line 8-8 of FIG. 7.

FIG. 9 depicts a side perspective view of a gasket member of the present invention.

FIG. 10 depicts a side partially exploded view of a conventional heater treater vessel equipped with a flange member of the present invention.

FIG. 11 depicts a side view of a conventional heater treater vessel equipped with a flange member of the present invention.

### DETAILED DESCRIPTION OF A PREFERRED EMBODIMENT

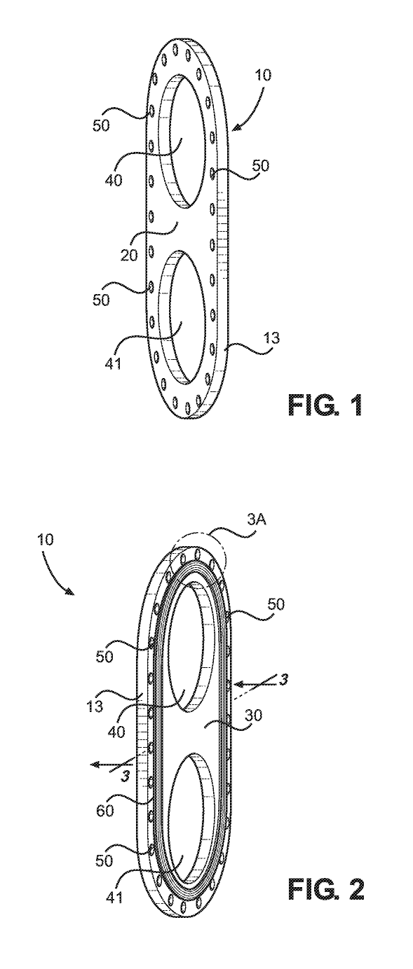

Referring to the drawings, FIG. 1 depicts a perspective view of a raised face blind flange member 10 of the present invention including, without limitation, outer surface 20 thereof. In a preferred embodiment, raised face blind flange member 10 of the present invention comprises a substantially planar member having a substantially flat outer surface 20 and oval outer shape defining circumferential edge 13.

Still referring to FIG. 1, said raised face blind flange member 10 has a plurality of holes 40 and 41 for receiving a fire tube of a conventional heater treater or other heated separator vessel, as described more fully herein. Further, a plurality of bores 50 is disposed around said oval-shaped, raised face blind flange member in spaced relationship, and provide apertures for receiving fasteners.

FIG. 2 depicts a side perspective view of an inner surface 30 of said raised face blind flange member 10 of the present invention (generally representing the opposite side of said raised face blind flange member 10 that is depicted in FIG. 1). Raised face blind flange member 10 has substantially oval outer shape defining circumferential edge 13. Holes 40 and 41 extend through said raised face blind flange member 10 for receiving a fire tube of a conventional heater treater or other heated separator vessel (not shown in FIG. 2). A plurality of bores 50 is disposed around said oval-shaped, raised face blind flange member in spaced relationship.

A raised section 60—that is, an area having a greater thickness than the remainder of said flange member 10—forms a substantially-oval shaped loop and is disposed along inner surface 30 of flange member 10. Said raised section 60 is generally positioned in a space formed between bores 50, on one side, and holes 40 and 41 on the other. Put another way, said holes 40 and 41 are disposed inside of a closed loop formed by raised section 60.

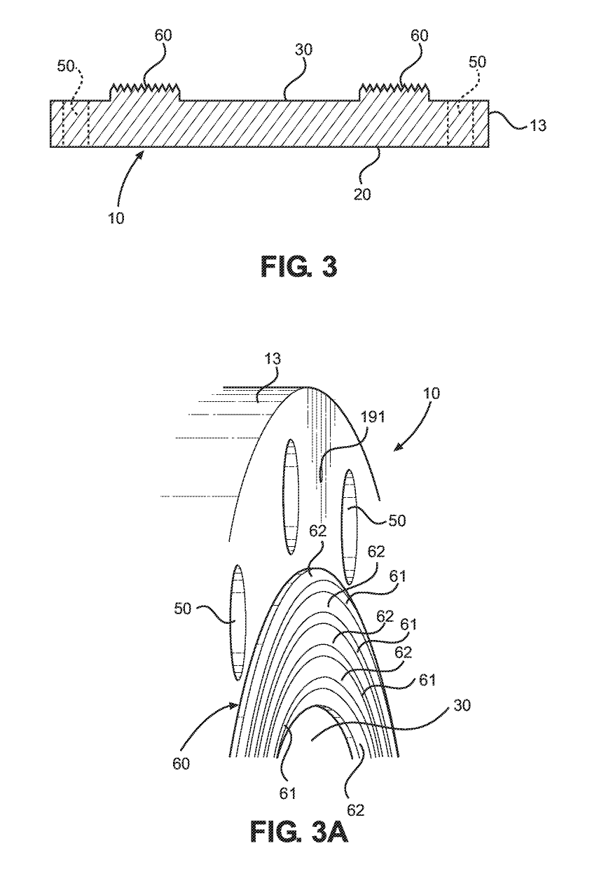

FIG. 3 depicts a sectional view of a raised face blind flange member 10 of the present invention along line 3-3 of FIG. 2. Raised face blind flange member 10 has inner surface 30, outer surface 20, and outer circumferential edge 13; in a preferred embodiment, said inner surface 30 and outer surface 20 are substantially flat. Although not visible in FIG. 3, it is to be observed that holes 40 and 41 extend through said flange member from inner surface 30 to outer surface 20. A plurality of bores 50 is disposed around said oval-shaped, raised face blind flange member 10 in spaced relationship. Raised section or area 60 protrudes or extends from inner surface 30 of flange member 10.

FIG. 3A depicts a detailed view of the area highlighted area “3A” depicted in FIG. 2. Raised face blind flange member 10 has substantially flat inner surface 30 and outer circumferential edge 13. A plurality of bores 50 is disposed around said oval-shaped, raised face blind flange member 10 in spaced relationship. Raised section 60 protrudes or extends from inner surface 30 of flange member 10, and defines a plurality of substantially parallel and alternating grooves 61 and ridges 62. As depicted in FIG. 3A, said ridges 62 have substantially flat upper surfaces; however, it is to be observed that said upper surfaces of said ridges can have other shapes including, without limitation, pointed edges or rounded edges.

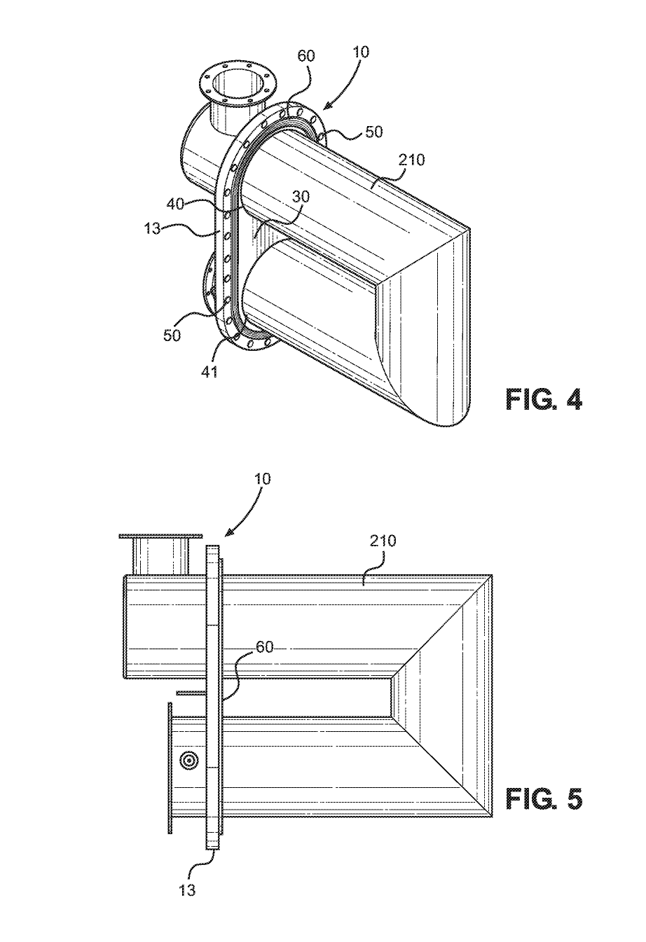

FIG. 4 depicts a side perspective view of raised face blind flange member 10 of the present invention equipped with a conventional fire tube 210, while FIG. 5 depicts a side view of said raised face blind flange member 10 of the present invention equipped with said conventional fire tube 210. Referring to FIGS. 4 and 5, raised face blind flange member 10 has substantially flat inner surface 30 and oval shape defining outer circumferential edge 13. Fire tube 210, the general design and configuration of which is well known to those having skill in the art, is disposed through holes 40 and 41 that extend through said raised face blind flange member 10. A plurality of bores 50 is disposed around said oval-shaped, raised face blind flange member in spaced relationship. Raised section 60 forms a substantially-oval shaped loop and is disposed along inner surface 30 of flange member 10, and is generally positioned between bores 50, on one side, and holes 40 and 41 on the other. Put another way, raised section or area 60 forms a loop that substantially extends around conventional fire tube 210.

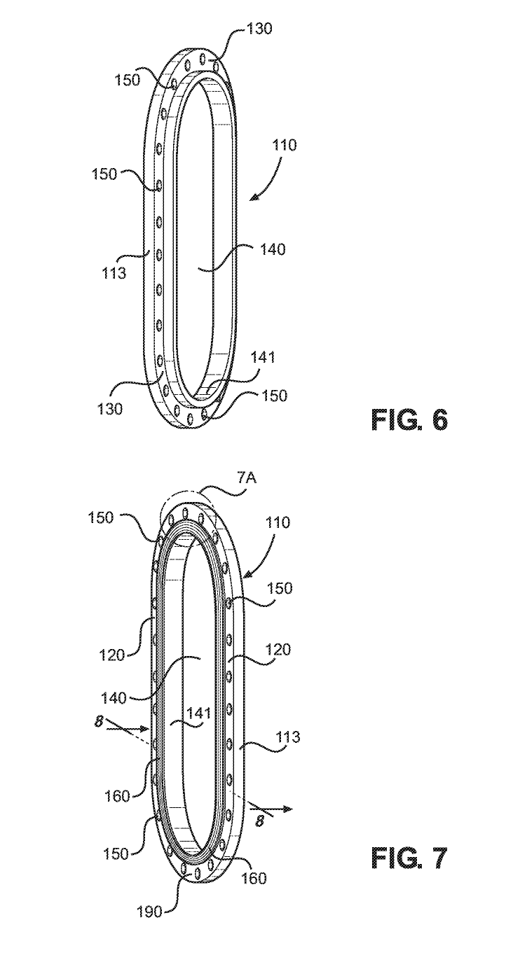

FIG. 6 depicts a side perspective view of a raised face slip-on flange member 110 of the present invention including, without limitation, inner surface 130 thereof. In a preferred embodiment, raised face slip-on flange member 110 of the present invention comprises a substantially planar member having a substantially oval outer shape defining circumferential edge 113. Said raised face slip-on flange member 110 has a central opening 140; slip-on lip member 141 is disposed around the outer edge of said central opening. In a preferred embodiment, said slip-on lip member 141 is oriented substantially perpendicular to substantially planar flange member 110. Further, a plurality of bores 150 is disposed around said oval-shaped, raised face slip-on flange member 110 in spaced relationship, and provide apertures for receiving fasteners.

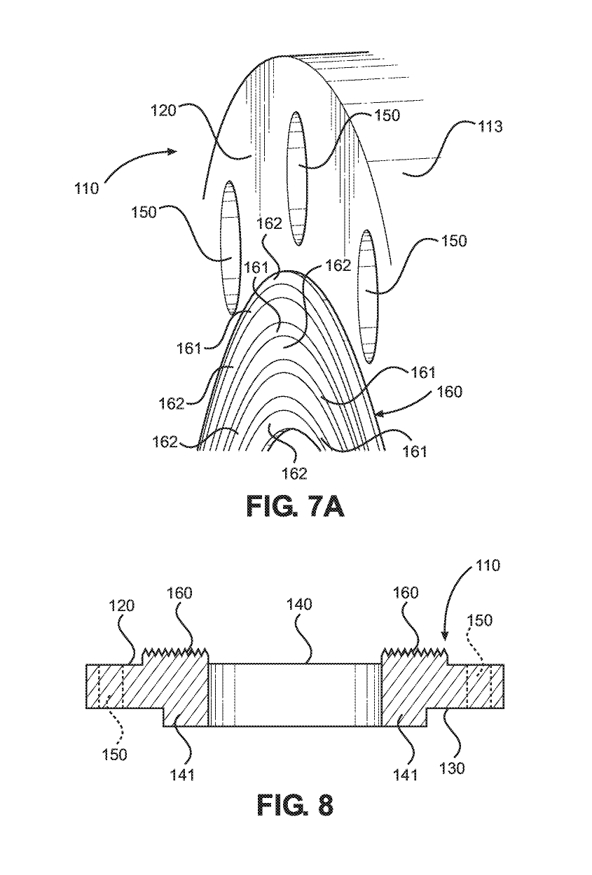

FIG. 7 depicts a side perspective view of an outer surface 120 of said raised face slip-on flange member 110 of the present invention (generally representing the opposite side of said raised face slip-on flange member 110 that is depicted in FIG. 6). Raised face slip-on flange member 110 has central opening 140 and a substantially oval outer shape defining circumferential edge 113; slip-on lip member 141 is disposed around said central opening 140 and is oriented substantially perpendicular to substantially planar flange member 110. A plurality of bores 150 is disposed around said oval-shaped, raised face slip-on flange member 110 in spaced relationship. Raised section 160—that is, a portion having a greater thickness than the remainder of slip-on flange member 110—forms a substantially-oval shaped loop and is disposed along outer surface 120 of flange member 110, and is generally positioned in a space formed between bores 150, on one side, and central opening 140 on the other.

FIG. 7A depicts a detailed view of the area highlighted area “7A” depicted in FIG. 7. Raised face slip-on flange member 110 has substantially flat outer surface 120 and outer circumferential edge 113. A plurality of bores 150 is disposed around said oval-shaped, raised face blind flange member 110 in spaced relationship. Raised section 160 protrudes or extends from said outer surface 120 of flange member 110, and defines a plurality of substantially parallel and alternating grooves 161 and ridges 162. As depicted in FIG. 7A, said ridges 162 have substantially flat upper surfaces; however, it is to be observed that said upper surfaces of said ridges 162 can have other shapes including, without limitation, pointed edges or rounded edges without departing from the scope of the present invention.

FIG. 8 depicts a side sectional view of a raised face slip-on flange member 110 of the present invention along line 8-8 of FIG. 7. Raised face slip-on flange member 110 has outer surface 120, inner surface 130, and outer circumferential edge 113; in a preferred embodiment, said inner surface 130 and outer surface 120 are substantially flat and generally oriented parallel relative to each other. Raised face slip-on flange member 110 has central opening 140 and slip-on lip member 141; said slip-on lip member 141 is disposed around said central opening 140 and is oriented substantially perpendicular to outer surface 120 and inner surface 130. A plurality of bores 150 is disposed around said oval-shaped, raised face slip-on flange member 110 in spaced relationship. Raised section or area 160 protrudes or extends from outer surface 120 of flange member 110.

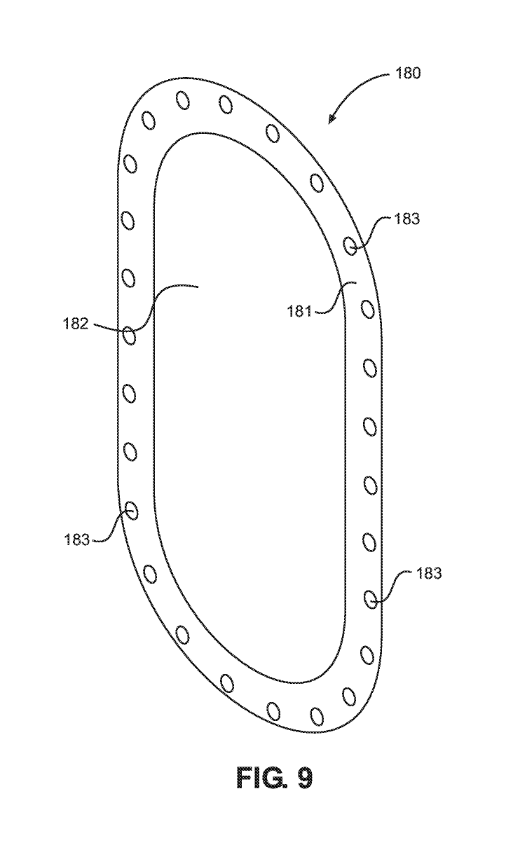

FIG. 9 depicts a side perspective view of a gasket member 180 of the present invention. Gasket member 180 generally has substantially flat and oval-shaped body section 181 defining a loop having a central opening 182. A plurality of bores 183 is disposed around said gasket member 180 in spaced relationship. It is to be observed that said gasket member 180 is designed to be received between opposing inner surface 30 of blind flange member 10 and outer surface 120 of slip-on flange member 110. In this position, apertures 183 can be aligned between (also aligned) apertures 50 and 150 of said blind flange member 10 and slip-on flange member 110, respectively. Gasket member 180 can comprise any number of different materials including, without limitation, flat ring sheet types and/or metallic composites such as spiral wound and double jacketed types well known to those having skill in the art.

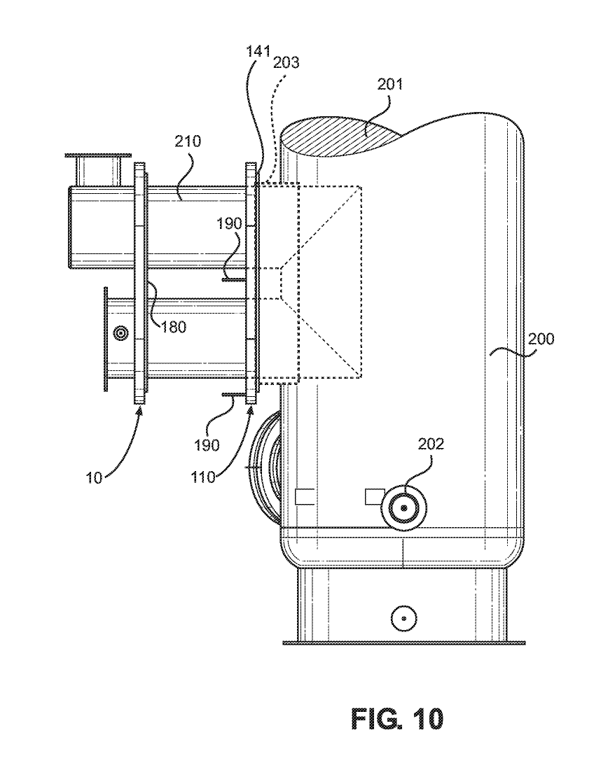

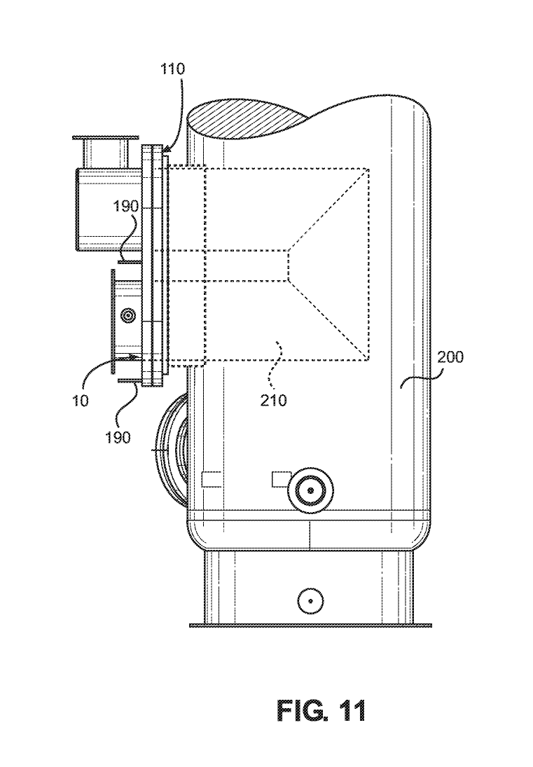

FIG. 10 depicts a side partially exploded view of a conventional heater treater vessel 200 equipped with the raised face flange members of the present invention. As depicted in FIG. 10, heater treater vessel 200 defines inner chamber 201, and has external drain ports 202. Fire tube port neck 203 extends outward from said heater treater vessel 200 and substantially surrounds an opening for receiving a fire tube, such as fire tube 210. In this configuration, outer surface 120 and raised section or area 160 of said raised face slip-on flange member 110 face outward relative to heater treater vessel 200.

Still referring to FIG. 10, slip-on flange member 110 is disposed on said heater treater vessel 200. Specifically, as depicted in FIG. 10, slip-on lip member 141 is sized so that it can fit over/around fire tube port neck 203; said slip-on lip member 141 is then welded or otherwise permanently attached to said fire tube port neck 203, with an impervious fluid pressure seal.

Fire tube 210 is received within bores 40 and 41 (not visible in FIG. 10) of blind flange member 10, and said blind flange member 10 is aligned with slip-on flange member 110. In a preferred embodiment, dimensions of said raised face blind flange member 10 are substantially consistent with the dimensions of said raised face slip-on flange member 110, allowing said opposing flange members to be secured together against each other in mating face-to-face relationship, with gasket member 180 disposed there between. Said gasket member 180 is beneficially compressed, thereby energizing said gasket member and creating a fluid pressure seal.

Still referring to FIG. 10, at least one alignment pin 190 extends outwardly from said raised face slip-on flange member 110 in a substantially perpendicular orientation or direction. In a preferred embodiment, said at least one alignment pin 190 is substantially cylindrical in shape; however, it is to be observed that other protruding extensions having other shapes can be used without departing from the scope of the present invention. At least one mating alignment aperture is provided on said raised face blind flange member 10; said at least one alignment aperture is beneficially vertically and horizontally aligned with said at least one alignment pin 190, and is adapted to receive said at least one alignment pin 190 when said blind flange member 10 and slip-on flange member 110 are moved together in joined relationship.

During installation of a fire tube (such as fire tube 210) into a heater treater vessel (such as heater treater vessel 200), the weight and configuration of said fire tube 210 can make it difficult to properly align said fire tube relative to said heater treater vessel opening. For example, said fire tube 210 can have a tendency to “skew”, such that it does not enter heater treater vessel 200 in a truly horizontal alignment which, in turn, can cause blind flange member 10 to tilt from a vertical orientation. Such tiling of blind flange member 10 can cause difficulty when attempting to align blind flange member 10 with slip-on flange member 110 in a substantially flush or face-to-face orientation.

In order to aid such alignment, said at least one alignment pin 190 can be aligned with and slidably received in opposing aperture(s) in blind flange member 10 (such as aperture 191 depicted in FIG. 3A) before fire tube 210 is fully inserted into heater treater vessel 200. When at least partially inserted within an opposing aperture 191, said at least one alignment pin 190 prevents said blind flange member 10 from tilting from vertical and keeps said blind flange member 10 oriented substantially parallel with slip-on flange member 110, particularly as said flange members 10 and 110 are moved together. As fire tube 210 penetrates deeper into heater treater vessel 200, blind flange member 10 and slip-on flange member 110 remain substantially parallel to each other until they ultimately meet in face-to-face opposing relationship.

In a preferred embodiment, bores 150 disposed around said raised face slip-on flange 110 member are aligned with bores 183 of gasket member 180 and bores 50 disposed around said raised face blind flange member 10. Fasteners can be received within each set of aligned bores in order to apply compressive forces to said opposing flange members and secure said opposing flange members 10 and 110 together. By way of illustration, but not limitation, said fasteners can each comprise threaded bolts and threaded nuts; however, other fasteners can be used without departing from the scope of the present invention.

In a preferred embodiment, each of said oval-shaped, raised face blind flange member 10 and said oval-shaped, raised face slip-on flange member 110 complies with ANSI B16.5 Class 75, 150, 300, 600, and/or 900 series specifications, including bolt pattern and type requirements. Further, gasket member 180 comprises a non-asbestos sealing gasket, and is disposed between said opposing flange members 10 and 110.

Referring to FIGS. 3 and 8, raised section or area 160 protrudes or extends from outer surface 120 of flange member 110, while opposing raised section 60 protrudes or extends from inner surface 30 of flange member 10. It is to be observed that said raised face sections or areas 160 and 60 are raised above or extend beyond the other opposing surfaces of said flange members. As such, said raised sections or areas 160 and 60 concentrate more pressure on a smaller area of gasket member 180, with ridges 62 and 162, respectively, optionally penetrating and/or deforming said compressed gasket member 180, thereby increasing the pressure containment capability of mated flange members 10 and 110.

The present invention eliminates current risks and limitations associated with conventional flange designs. Among other benefits, the flange assembly of the present invention provides improved safety, and allows for quick and efficient replacement and/or repair. Further, because said flange assembly provides greater fluid pressure sealing capacity, said flange assembly of the present invention permits safe operation of heater treaters and/or other heated separator vessels at higher MAWPs.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A[n] flange assembly for operationally attaching a fire tube to a heater treater vessel comprising:
a) a blind flange member having a substantially oval shape, an inner surface, an outer surface, a plurality of holes extending from said inner surface to said outer surface configured to receive said fire tube, and a raised face extending from said inner surface;
b) a vessel flange member disposed around an opening of said heater treater vessel having a substantially oval shape, an inner face, an outer face, a central opening, and a raised face extending from said outer surface; and
c) a gasket member disposed between said raised faces of said blind flange member and vessel flange member.

2. The flange assembly of claim 1, wherein at least one of said raised faces of said blind flange member and vessel flange member further comprise a plurality of grooves.

3. The flange assembly of claim 2, wherein said grooves have pointed upper surfaces.

4. The flange assembly of claim 1, wherein said gasket member is compressed by said raised faces.

5. The flange assembly of claim 1, further comprising at least one elongate pin extending from said vessel flange member, wherein said pin is slidably received in an aligned aperture in said blind flange member.

6. The flange assembly of claim 5, wherein said elongate pin is oriented substantially perpendicular to said vessel flange.

7. A flange assembly for operationally attaching a fire tube to a heater treater vessel comprising:
a) a blind flange member having a substantially oval shape, an inner surface, an outer surface, a plurality of holes extending from said inner surface to said outer surface configured to receive said fire tube, and a raised face extending from said inner surface;
b) a vessel flange member disposed around an opening of said heater treater vessel having a substantially oval shape, an inner face, an outer face, a central opening, and a raised face extending from said outer surface;
c) a gasket member disposed between said raised faces of said blind flange member and vessel flange member; and
d) at least one elongate pin extending from said vessel flange member, wherein said pin is slidably disposed in an aligned aperture in said blind flange member.

8. The flange assembly of claim 7, wherein at least one of said raised faces of said blind flange member and vessel flange member further comprise a plurality of grooves.

9. The flange assembly of claim 8, wherein said grooves have pointed upper surfaces.

10. The flange assembly of claim 7, wherein said gasket member is compressed by said blind flange member and vessel flange member.

11. The flange assembly of claim 7, wherein said elongate pin is oriented substantially perpendicular to said vessel flange member.

12. A method for installing a fire tube in a heater treater vessel comprising:
a) providing a flange assembly comprising:
(i) a blind flange member having an inner surface, an outer surface, and a plurality of holes extending from said inner surface to said outer surface, wherein said fire tube is disposed within said plurality of holes;
(ii) a vessel flange member disposed around an opening of said heater treater vessel having an inner face, an outer face, and a central opening;
iii) a gasket member disposed between said blind flange member and vessel flange member;
vi) at least one elongate pin extending from said vessel flange member, wherein said pin is oriented substantially perpendicular to said vessel flange member;
b) inserting a portion of said at least one elongate pin within an aligned aperture in said blind flange member; and
c) moving said blind flange member toward said vessel flange, wherein said elongate pin is slidably received within said aperture in said blind flange member.

13. The method of claim 12, wherein said blind flange member and said vessel flange member have oval shapes.

14. The method of claim 12, further comprising a raised face extending from said inner surface of said blind flange member and a raised face extending from said outer surface of said vessel flange member.

15. The method of claim 14, wherein at least one of said raised faces of said blind flange member and vessel flange member further comprise a plurality of grooves.

16. The method of claim 15, wherein said grooves have pointed upper surfaces.

17. The method of claim 16, wherein said gasket member is compressed by said blind flange member and vessel flange member.
